(19) United States
(12) Patent Application Publication
(10) Pub. No.: US 2007/0070980 A1
(43) Pub. Date: Mar. 29, 2007

(54) Method and system for providing network-based call processing of packetized voice calls

(75) Inventors: David E. Phelps, Colorado Springs, CO (US); Brian Badger, Colorado Springs, CO (US)

Correspondence Address: VERIZON;PATENT MANAGEMENT GROUP, 1515 N. COURTHOUSE ROAD, SUITE 500, ARLINGTON, VA, 22201-2909, US

(73) Assignee: MCI, Inc., Ashburn, VA (US)

(21) Appl. No.: 11/235,833

(22) Filed: Sep. 27, 2005

(51) Int. Cl. H04L 12/16; H04L 12/66; H04Q 11/00

(52) U.S. Cl. 370/352; 370/270

(57) ABSTRACT

An approach provides network-based call processing. A packetized voice call is received from a first station. The packetized voice call is queued at a pre-designated queue maintained within a network of a service provider. Further, the packetized voice call is selectively forwarded to a second station.

### FIELD OF THE INVENTION

The present invention relates to communications, and more particularly, to call processing.

### BACKGROUND OF THE INVENTION

The popularity and convenience of the Internet has resulted in the reinvention of traditional telephony services. These services are offered over a packet switched network with minimal or no cost to the users. IP (Internet Protocol) telephony, thus, have found significant success, particularly in the long distance market. In general, IP telephony, which is also referred to as Voice-over-IP (VOIP), is the conversion of voice information into data packets that are transmitted over an IP network. Users, such as including enterprises, also have turned to IP telephony as a matter of convenience in that both voice and data services are accessible through a single piece of equipment, namely a personal computer. The continual integration of voice and data services further fuels this demand for IP telephony applications.

The Session Initiation Protocol (SIP) has emerged to address the signaling of calls over an IP network. As an end-to-end protocol, call features such as IP transfers are conducted by the SIP endpoints. That is, transfers are initiated and orchestrated by SIP endpoints through use of the SIP Refer method. However, in the SIP architecture, it is desirable for an intermediate network element to control the call processing.

It is recognized that efficiencies and economies of scale cannot be achieved with a purely endpoint-based signaling approach. In addition, certain call treatments and features are simply not possible with an endpoint-based signaling approach.

Furthermore, from the perspective of service providers, relinquishment of control, among other concerns, is undesirable in that network-based transfer features provide a source of revenue. With endpoint-based signaling, users no longer need to pay the service provider for call features such as a transfer capability, as they can perform transfer VoIP calls on their own.

Based on the foregoing, there is a clear need for value-added network-based call features and treatment.

### SUMMARY OF THE INVENTION

These and other needs are addressed by the present invention, in which an approach for performing network-based call processing is provided.

According to one aspect of the present invention, a method for providing network-based call processing is disclosed. The method comprises receiving a packetized voice call from a first station. The method also comprises queueing the packetized voice call at a pre-designated queue maintained within a network of a service provider. Further, the method comprises selectively forwarding the packetized voice call to a second station.

According to another aspect of the present invention, a system for providing call processing within a network of a service provider is disclosed. The system comprises a queue configured to receive a packetized voice call from a first station. Additionally, the system comprises a call processor configured to select the queue, wherein the packetized voice call is selectively forwarded to a second station.

According to yet another aspect of the present invention, a communication system for supporting network-based call processing of packetized voice calls is disclosed. The system comprises a gateway configured to receive a first leg of a packetized voice call from a first endpoint. Also, the system comprises a service controller configured to establish a second leg of the call with a second endpoint. The system additionally comprises an application server configured to receive signaling for parking the first call leg. Further, the system comprises a media server configured to park the first call leg, and to bridge the first call leg and the second call leg.

Still other aspects, features, and advantages of the present invention are readily apparent from the following detailed description, simply by illustrating a number of particular embodiments and implementations, including the best mode contemplated for carrying out the present invention. The present invention is also capable of other and different embodiments, and its several details can be modified in various obvious respects, all without departing from the spirit and scope of the present invention. Accordingly, the drawings and description are to be regarded as illustrative in nature, and not as restrictive.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagram of a communication system capable of providing call parking of inbound calls in support of call center services, according to an embodiment of the present invention;

FIGS. 2A-2C are flowcharts of processes of transferring inbound calls in the system of FIG. 1, according to various embodiments of the present invention;

FIG. 3 is a diagram of an exemplary architecture of the service provider network in the system of FIG. 1 for supporting packetized voice call transfer, according to an embodiment of the present invention;

FIG. 4 is a call flow diagram associated with inbound and outbound call legs to a media server, according to an embodiment of the present invention;

FIG. 5 is a diagram showing network bridging of call legs, according to an embodiment of the present invention;

FIG. 6 is a call flow of a Session Initiation Protocol (SIP) Refer method without media, according to an embodiment of the present invention;

FIG. 7 is a call flow of a SIP Refer method with media (retrieve from the network), according to an embodiment of the present invention;

FIG. 8 is a call flow of a SIP Refer method with media (outdial), according to an embodiment of the present invention;

FIG. 9 is a call flow of a SIP Refer method with media (network bridge), according to an embodiment of the present invention; and

FIG. 10 is a diagram of a computer system that can be used to implement an embodiment of the present invention.

### DESCRIPTION OF THE PREFERRED EMBODIMENT

An apparatus, method, and software for providing network-based call processing are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

Although the various embodiments of the present invention are described with respect to the Internet Protocol (IP) based voice sessions and call center services, it is contemplated that these embodiments have applicability to other communication protocols and telecommunication services.

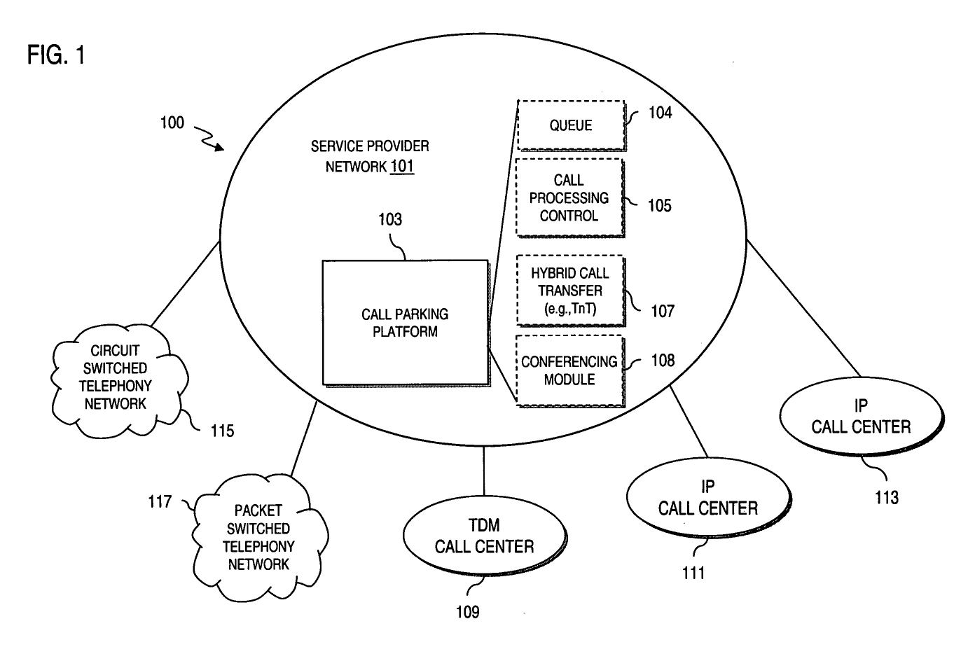

FIG. 1 is a diagram of a communication system capable of providing call parking of inbound calls in support of call center services, according to an embodiment of the present invention. By way of example, the communication system 100 includes a network operated by a telecommunications service provider, denoted as a service provider network 101. The service provider network 101 offers a variety of network-based telecommunication services, as it is recognized that certain types of services may benefit from the ability to control call routing and call parking within the network 101 itself rather than at a customer premise equipment (CPE) or telephone terminal devices. For example, in the context of call center services, it is useful to park or queue an inbound call within the network 101.

As shown, the network 101 includes a call processor (or call processing system) 103 that provides call processing for handling packetized voice sessions or calls involving parking of call legs. Accordingly, as used herein, the call processor 103 is also denoted as a “call parking platform.” The platform 103 can be implemented using a number of architectures to provide parking and transfer of packetized voice calls. The packetized voice calls can, for example, be VoIP (Voice over Internet Protocol) calls. In an exemplary embodiment, the platform 103 includes the following components: a queue 104, a call processing control module 105, a hybrid call transfer module 107, and a conferencing module 108.

In addition to packetized voice calls, the call parking platform 103 can also handle traditional circuit switched calls (e.g., Dual Tone Multi-Frequency initiated calls). According to one embodiment of the present invention, the call parking platform 103 supports the parking of inbound call legs to transfer the calls among various call centers 109, 111 and 113. In this example, the call center 109 is a Time Division Multiplexing (TDM) system, while the call centers 111 and 113 support packetized voice calls (e.g., VoIP calls).

The IP Transfer module 107, according to one embodiment of the present invention, allows the called party to transfer a call to another location; the call is redirected without requiring the caller to disconnect and redial. In other words, a call that has been completed to a call center agent and one call center may cause the call to be effectively “taken back” at the call parking platform 103, and then transferred to another agent in another call center. This advantageously avoids having to loop the call through the first call center for its entire duration, as well as having to perform extensive and expensive trunking between each pair of cooperating call centers.

The service provider network 101 interfaces with a circuit switched telephony network 115—for example, the Public Switched Telephone Network (PSTN). Also, the network 115 has connectivity to a packet switched telephony network 117 (e.g., the global Internet).

In an enterprise scenario, the organization may operate multiple call centers 109, 111, and 113 in geographically separate locations. To reach the enterprise, inbound calls may first be routed to a network-resident platform where the call is initially handled by an automatic voice response unit (VRU), Automatic Call Distribution (ACD) platform, or the like. At this point, the call may be selectively routed to a particular one of the multiple call centers 109, 111, and 113. The routing of the call may is often chosen based upon relative loading among the call centers 109, 111, and 113 or the specific type of service requested by the caller as determined by interaction with the VRU.

Under certain circumstances, the call centers 109, 111, and 113, which are equipped to handle the inbound call, may be unavailable—busy assisting other callers—so an inbound call is temporarily “parked” at the network resident platform (e.g., call parking platform 103). When an appropriate call center agent at one of the call center locations becomes available, then the call is connected through to the agent. By contrast, in the conventional approach (without in-network call parking), the inbound call is queued at an ACD (not shown) at a specific one of the call centers 109, 111, and 113. The call would remain in the particular queue, even if an agent became available at another call center.

The in-network approach supported by the system 100 for handling inbound calls has several advantages. One advantage is that load balancing among the geographically dispersed call centers 109, 111, and 113 can readily be performed. Also, the parking resources (e.g., call parking platform 103) can be shared among the call centers 109, 111, and 113. These resources can additionally be utilized more efficiently in that better overall handling of inbound calls are enabled, as opposed to designing excess capacity into an ACD or having to add more agents. Further, the service provider can provide greater efficiencies to customers who employ call centers, as the parking resources can be distributed among these customers.

The network 101 can also provide an intelligent call routing (ICR), whereby the enterprise client can interface with the call processing functions (e.g., module 105) of the service provider's network to effect how the provider routes the calls to its various call centers 109, 111, and 113.

The network 101 employs, according to one embodiment of the present invention, the Session Initiation Protocol (SIP) to exchange messages. A detailed discussion of SIP and its call control services are described in Internet Engineering Task Force (IETF) Request for Comment (RFC) 2543, entitled “SIP: Session Initiation Protocol”; RFC 3515, entitled “The Session Initiation Protocol (SIP) Refer Method”; RFC 3261, entitled “SIP: Session Initiation Protocol”; and RFC 3725, entitled “Best Current Practices for Third Party Call Control (3 pcc) in the Session Initiation Protocol (SIP)”; all of which are incorporated herein by reference in their entireties. SIP is used to create and terminate voice calls over a data network. However, it is understood that one of ordinary skill in the art would realize that the H.323 protocol and similar protocols can be utilized in lieu of SIP. The H.323 protocol, which is promulgated by the International Telecommunication Union (ITU), specifies a suite of protocols for multimedia communication. SIP is a signaling protocol that is based on a client-server model. It should be noted that both the H.323 protocol and SIP are not limited to IP telephony applications, but have applicability to multimedia services in general.

Since SIP can be used for signaling, a media session transported using schemes such as RTP (Reliable Transport Protocol)/UDP (User Datagram Protocol), RTP/TCP (Transmission Control Protocol), RTP/SCTP (Stream Control Transmission Protocol), and AAL (ATM Adaptation Layer)/ATM (Asynchronous Transfer Mode) among many others; this service allows calling between schemes in an efficient way.

The transfer feature (denoted “IP Transfer”), according to an embodiment of the present invention, advantageously permits transfer control logic to remain within the service provider network 101—and thus, retain a viable revenue source. One key feature is the Takeback and Transfer (TnT) capability, which is explained below. In addition, with control logic being resident within the network, other network features, such as Network Call Redirect, Busy Ring No Answer, Reporting, “8xx” routing, Intelligent Call Routing (ICR), Enhanced Voice Services (EVS) routing plans, conferencing, and databases can be leveraged to provide value added services.

According to one embodiment of the present invention, IP Transfer is initiated by the SIP Refer method, but executed in the context of Third Party Call control. This advantageously supports transfer initiation using standard SIP methods, while permitting control logic to remain within the network.

One aspect of the present invention is the support for transfers from one customer call center to another customer call center—which is not practical if the transfer control logic resides within the endpoints. Performing this transfer within the network (i.e., “in the cloud”) is significantly more cost effective for the customers than installing and paying for interconnect trunks between each of their call centers.

The emergence of enterprise IP Telephony provides an alternative to the customers for transferring their customer calls between processing centers. With IP telephony in place enterprise wide, companies can transfer calls entirely within their own IP networks. However, a network centric approach advantageously provides customers with quality of service, reliability, a seamless transition to IP, as well as the benefits of TnT, in a cost-effective manner.

In terms of cost savings, it is noted that processing resources (e.g., Digital Signal Processing (DSP) resource) are not needed for TnT capable IP calls that are past the Interactive Voice Response (IVR) stage—e.g., when a caller is bridged with an agent. If the transfer is out of band, (meaning non-DTMF (Dual Tone Multi-Frequency) initiated) calls do not have to be “hair-pinned” through a VRU (with expensive DSP resources) to monitor for in-band DTMF digits. Instead an IP transfer can be initiated via SIP messaging or via another mechanism, such as a web-services interface. Use of these non-DTMF methods to initiate a transfer can reduce the cost of providing this service in the service provider network.

IP transfers can improve the service provider's ability to integrate with other VRU vendors in a standardized manner. IP transfers also provide enhanced reporting because IP RLT supports greater visibility into calls than traditionally supported.

Additionally, the infrastructure for supporting IP transfer can also provide a capability for monitoring the maximum number of calls allowed (e.g., via a parameter Max Calls Allowed).

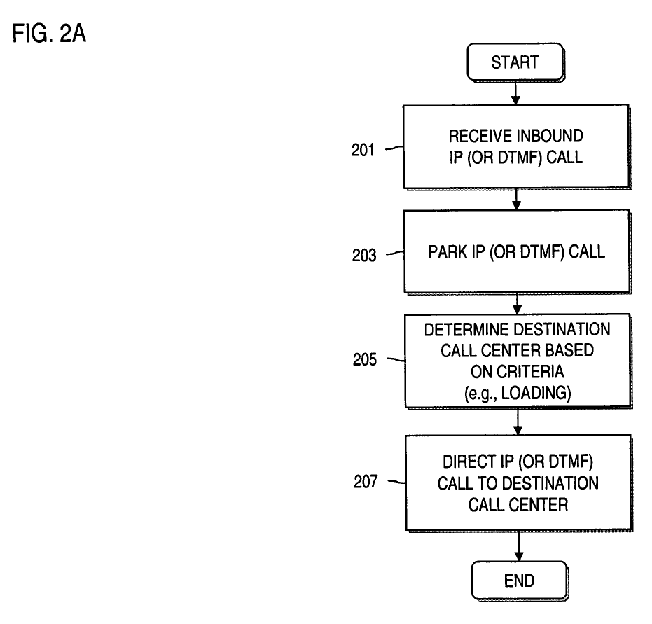

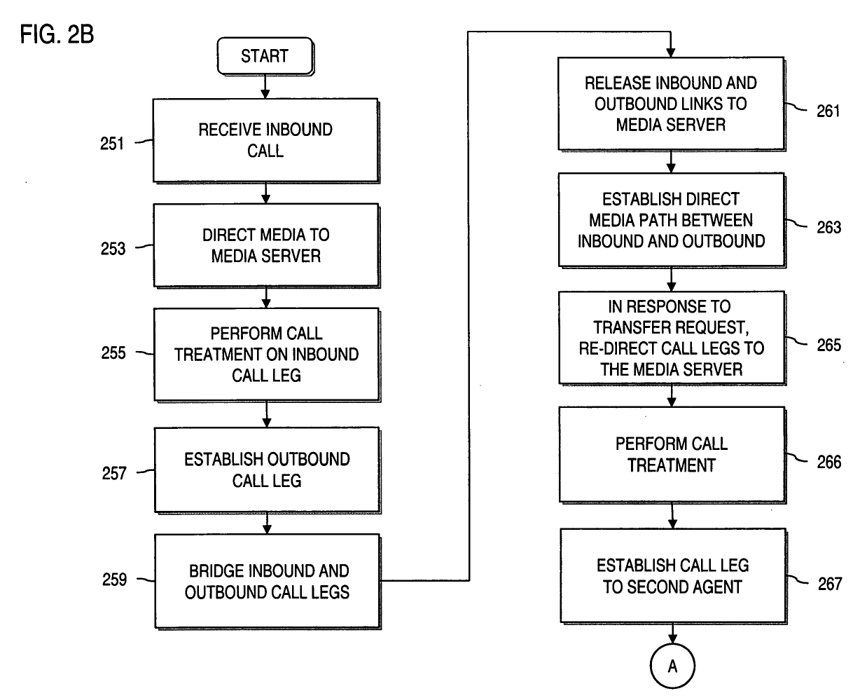

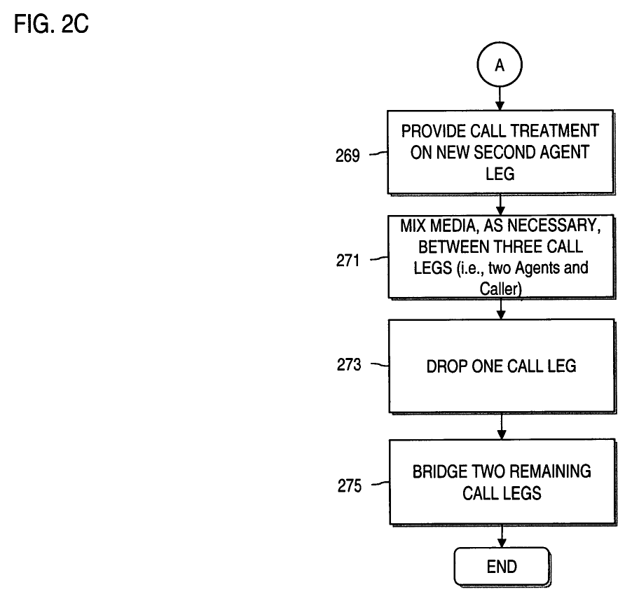

FIGS. 2A-2C are flowcharts of processes of transferring inbound calls in the system of FIG. 1, according to various embodiments of the present invention. As seen in FIG. 2A, per step 201, the service provider network 101 receives an inbound call, which can be an IP-based call or a DTMF call; the inbound call is destined for one of the call centers 109, 111 and 113. For the purposes of illustration, the TnT module 107 takes a call initially parked with the call center 111 and parks the call within the service provider network 101. The call is parked by the call parking platform 103 within its queue, per step 203. The call parking platform 103, as in step 205, namely, the call processing control module 105, determines a destination call center based on one or more criteria, for example, loading of the call center. That is, it may be desirable to load balance across the call centers 109, 111 and 113, so that the caller can be serviced expeditiously and the resources of the customer (or subscriber) are utilized efficiently. In step 207, the IP call is directed to the appropriate call center (e.g., 109, 111 or 113) based on loading. For example, if the call parking platform 103 determines that the IP call center 113 has no calls queued in its Automatic Call Distribution (ACD) or has a comparatively lower wait time, then the call center 113 is selected.

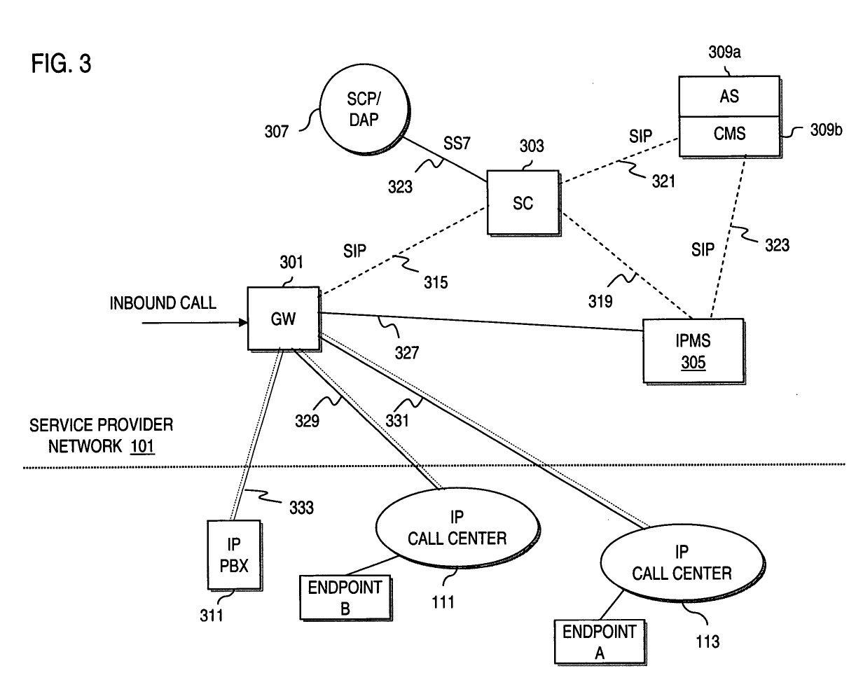

In another scenario, an inbound packetized voice call is received by the call parking platform 103 from a caller, per step 251. The media corresponding to the call is directed, as in step 253, to a media server (not shown in FIG. 1). An exemplary media server is more fully described later with respect to FIGS. 3-9. Next, call treatment is performed on the inbound call leg, per step 255. In step 257, the outbound call leg is established; thereafter, the inbound call leg and the outbound call leg are bridged (step 259). The inbound and outbound links are then released, as in step 261, to the media server, and direct media path is established between the endpoints, per step 263. In step 265, upon receiving a transfer request, the call legs are redirected to the media server. Either of the call legs can receive call treatment, per step 266. Per step 267, a call leg is established to the second agent.

Thereafter, as shown in FIG. 2C, call treatment is provided on the new call leg to the second agent, per step 269. In step 271, the media is mixed, as necessary, between the three call legs—i.e., call legs established for the two agents and the caller. Per steps 273 and 275, one of the call legs is dropped, and the remaining two call legs are bridged. At this point, the process can provide for additional transfers, in which case steps 265-275 are repeated.

It is noted that early media can be played from the third call leg to the conference of the other two call legs, such that in band busy can be detected by the transferring party and the transfer is canceled, if necessary.

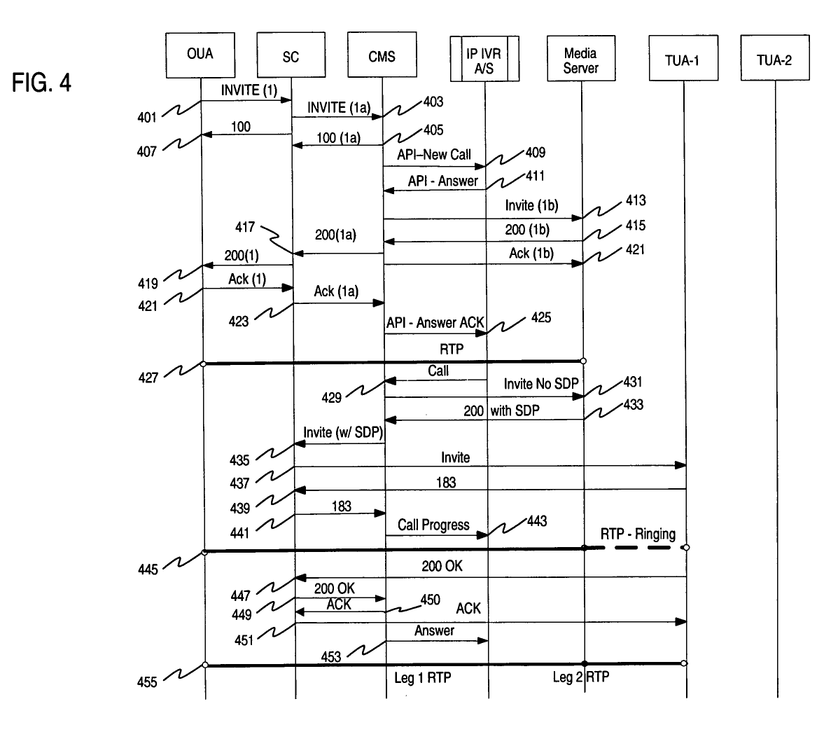

Exemplary call flows that illustrate use of the SIP Refer, in the context of third party call control, are shown in FIGS. 4-9.

FIG. 3 is a diagram of an exemplary architecture of the service provider network in the system of FIG. 1 for supporting packetized voice call transfer, according to an embodiment of the present invention. As noted, recent technologies have been developed, especially in the context of voice over packet and call processing based on the Session Initiation Protocol (SIP), which allow endpoint devices, such as IP telephones, to directly establish communication with one another. While this endpoint-based control approach offers advantages (and some challenges) in replicating many of traditional telephony services some environments, it is ill-suited for facilitating operations that benefit from network-centric control, such as in-network call parking and take-back-and-transfer operations that are fundamental in enterprise call center operations.

The network 101, according to one embodiment of the present invention, provides for employing SIP-based signaling, control elements and terminal devices in such a manner that the advantages of network-centric control are preserved. The call parking platform 103 can utilize SIP signaling and packet media streams (such as RTP) to perform Intelligent Call Routing (ICR), in-network call parking, and distant transfer operations.

For the purposes of illustration, the service provider network 101 includes a gateway 301 in communication with a Service Controller (SC) 303, and an IP Media Server (IPMS) 305. The SC 303 communicates using, for example, Signaling System 7 (SS7), with a Service Control Point (SCP) 307, and an Application Server (AS) 309a and a Common Media Services (CMS) module 309b. The AS 309a, among other functions, can provide IVR functions; in such case, the application server 309a can also be referred to as “IP IVR application server.” The CMS module 309b interfaces with the AS 309a, and can be implemented within a single computing platform (as shown) or separate computing platforms.

The IP transfer capability, according to an embodiment of the present invention, provides an IP endpoint with the ability to initiate transfer of a call that, for example, can functionally match the capabilities of TDM based TnT. For instance, the IP transfer mechanism, in an exemplary embodiment, can support blind, attended, and conference transfers. In the TDM environment, transfer is initiated by DTMF. DTMF transfer initiation can also be supported with IP transfer; in addition, out of band methods of transfer control can be utilized, such as SIP Refer and web services messages (or messages over an intelligent routing interface). Further, IP Transfer can provide transfers to IP and non-IP terminations including hybrid (IP to TDM or TDM to IP) transfers.

In order to support IP transfers that are initiated by non-DTMF means, common media services, as provided by the CMS module 309b, are utilized to implement a feature analogous to an RLT (Release Link Trunk) capability and a Retrieve back to the media server capability (“Un-RLT”). Akin to what RLT performs in the TDM environment, RLT in the IP environment releases DSP resources from a call. While remaining in the signaling path, the CMS module 309b would remove the media server 305 from the media stream redirecting the media stream to be transmitted directly from the originating user agent (OUA) to terminating user agent (TUA). The “Retrieve” command performs the opposite function, bringing the OUA and TUA media streams back to the media sever 305.

Unlike traditional RLT, after call legs are released via an IP RLT, the IP IVR application server 309a continues to remain cognizant of the call still in progress. The server 309a then will be the recipient of a transfer notification. Such a notification can be received via a SIP Refer message or via a web services message, or messages over an intelligent routing interface) (or messages over an intelligent routing interface. In an exemplary embodiment, call plan Service Independent Building Block (SIBB) constructs are created to support the IP RLT, IP Retrieve, and the non-DTMF TnT monitoring interfaces.

Given the architecture of FIG. 3, the network 101 can further offer call treatments and features that have been difficult or impossible to perform traditionally; such features cannot be readily accommodated using a purely endpoint-based SIP signaling approach. For example, the network 101 can allow a first agent in a first call center 111 to conference with a second agent in a second call center 113 while the inbound caller is placed on hold or receives other treatment. Also, the first agent can listen in on a conversation between the inbound caller and the second agent, and for the first agent to be able to talk to (or coach) the second agent during the dialogue with the caller without the caller being able to hear the first agent. Conventionally, these functions have been accomplished without extensive inter-trunking among the call centers, as would be the case if a purely endpoint-based approach were taken. By virtue of employing a network-centric platform, a wide variety of possible configurations are enabled and may be dynamically controlled by feature logic in profile settings expressed in the Application Server 309a that would be difficult or awkward to manage if the features relied entirely upon endpoint-based signaling. Management or deployment of new services is also greatly facilitated by centralization of some aspects of service processing.

The approach, in accordance with an exemplary embodiment, allows for transfers of the call into a queue (e.g., call parking platform 103 of FIG. 1). This approach provides an improvement over the typical SIP “REFER” or SIP “REPLACES” call control techniques in that the transferring endpoint may not need to transfer to a specific second endpoint, but instead refers the call to the queue 104 or refer the call to any member of a group of alternative endpoints.

In the example of FIG. 3, an inbound call arrives from the circuit switched telephony network 115 (of FIG. 1), which can be the PSTN, via the network gateway (i.e., GW) 301. Endpoints A and B can represent telephone devices corresponding to agents at the call centers 113 and 111, respectively. The IPMS 305 can “terminate” an RTP media stream from the GW 301 and serve as a voice-response unit, for example, by providing audible prompts to the caller, receiving DTMF or voice input from the user, etc.

The SC 303 serves to route SIP messages among the various elements shown, which in many ways is analogous to a SIP proxy server. It is noted that the SC 303 is optionally coupled to a traditional Intelligent Network (IN) Service Control Point 307 so that routing, such as ICR, may be performed in the traditional manner. A SIP Proxy is an intermediary entity that supports routing and forking, in addition to applying policy. In general, a SIP Proxy may not alter SIP messages and change message headers or body (except routing related headers such as Via).

The Application Server (AS) 309a coordinates the function of the other elements 301, 303 and 305 to accomplish the desired function or feature involving connections or sessions through the network 101. The AS 309a is where feature logic is executed or control scripts are maintained and performed. In SIP parlance, the AS 309a can essentially function as a back-to-back user agent (B2BUA) controller. The B2BUA is a logical entity that can receive and process INVITE messages as a SIP User Agent Server (UAS). The B2BUA can also behave as a SIP User Agent Client (UAC) with respect to how requests are answered and how outbound calls are initiated. Unlike a SIP proxy server, the B2BUA maintains complete call state and participates in all call requests, thereby permitting service providers to manage and track calls.

The Common Media Services (CMS) function 309b interfaces the Application Server 309a to the SIP signaling environment and translates commands issued by the Application Server 309a into one or more of the appropriate SIP signaling dialogues with the media server 305, and the service controller 303. The CMS function 309b, in part, handles the specifics of SIP-compliant transaction states, acknowledgments, timeout behavior, etc.

When a transfer is desired, various mechanisms may be used by endpoint A to notify the Application Server 309a that some form of park or transfer is being requested. Additionally, other forms of call transfer may be supported, including blind transfer, attended transfer or conferencing transfer. These mechanisms include, but are not limited to, in-band control using audible DTMF tones, out-of-band signaling using SIP between endpoint (e.g., Endpoints A and B) and the Application Server 309a, or through some form of signaling gateway by which the endpoint may indirectly signal to the Application Server 309a.

It is also contemplated that the service provider network 101 can accommodate a Private Branch Exchange (PBX) 311 that supports IP telephony. The IP PBX 311 has connectivity to the network 101 via the GW 301.

In the scenario of FIG. 3, the endpoint A conducts SIP signaling with the Application Server 309 via the SC 303 and CMS 309b. This is one mechanism for initiating transfer or other invoking other actions. Alternatively, an agent using endpoint A may have a computer workstation running an application that can communicate with the SC 303 or AS 309a. In another alternative embodiment, separate communications over a Local Area Network (LAN) and/or Wide Area Network (WAN) may be established through the GW 301 to accomplish signaling to a telecommunications control element that can effect transfer of the call.

Under the scenario of FIG. 3, the SC 303 behaves as a SIP proxy server, and as such, supports SIP signaling over links 315, 319 and 321, respectively, to the GW 301, the IP Call Center 113, the IPMS 305, and the AS 309a (and CMS 309b). In addition, the SC 303 has a link 323 supporting, for example, Signaling System 7 (SS7) to the SCP 307. The IPMS 305 communicates over a signaling link 323 to the CMS 309b and the AS 309a. Generally, the other links 327-333 are bearer channels for transporting data traffic (e.g., media). It is noted that the links 329, 331 and 333 also include SIP signaling links for communication between the GW 301 and the IP Call Center 111, IP Call Center 113, and IP PBX 311, respectively.

The network 101 advantageously enables a “hybrid” transfer, in which one endpoint can be an IP phone, agent, client, or station, for example; and the other is a traditional telephone in a circuit switched, TDM environment. This promotes both co-existence and a gradual migration path to an IP-based telephony system. Thus, an enterprise that operates call centers may simultaneously operate a mixture of packet-based and TDM-based call centers and may gradually shift from TDM to packet technologies as desired. This gradual migration minimizes up-front costs and downtime that would be required in a sudden cutover from an all-TDM to an all-packet implementation.

FIG. 4 is a call flow diagram associated with inbound and outbound call legs to a media server, according to an embodiment of the present invention. By way of example, the call flow utilizes SIP signaling. SIP messages are either requests or responses. User agents (not shown) may behave as either a user agent client (UAC) or a user agent server (UAS), depending on the services. In general, a user agent client issues requests, while a user agent server provides responses to these requests. SIP defines various types of requests, which are also referred to as methods. One method is the INVITE method, which invites a user to a conference. Another method is the ACK method, which provides for reliable message exchanges for invitations in that the client is sent a confirmation to the INVITE request. That is, a successful SIP invitation includes an INVITE request followed by an ACK request.

Upon receipt of a call by the GW 301 (of FIG. 3), the GW 301 signals to the SC 303, which establishes a bearer path to the IP media server 305. Specifically, in step 401, an Originating User Agent (OUA), or SIP Client (SIPC), transmits an INVITE message to the SC 303, which then forwards the INVITE to the CMS 309b (step 403). Under this scenario, anyone of the endpoints, A and B, can be the OUA, while the other is a Terminating User Agent (TUA). In response, the CMS 309b sends a “100 Trying” message to the SC 303; the SC 303 then forwards the “100 Trying” message to the OUA (per steps 405 and 407). In steps 409 and 411, the CMS 309b forwards an API—New call message to the AS 309a, which responds with an API—Answer message.

Next, the CMS 309b sends an INVITE message to the media server 305 (step 413); in turn, the server 305 transmits a “200 OK” message in response (step 415). In step 417, the CMS 309b forwards the “200 OK” message to the SC 303, which then relays the message to the OUA. The OUA then acknowledges the SC 303 with an ACK message, as in step 421. The SC 303 thereafter forwards the ACK to the CMS 309b, per step 423. In step 425, the CMS 309b sends an API—Answer Ack message to the AS 309a. At this point, the media server 305 can exchange media with the OUA (step 427).

In step 429, the AS 309a sends a Call message to the CMS 309b, and the CMS 309b responds by sending an INVITE (with no Session Description Protocol (SDP)) to the media server 305, per step 431. As described in the SIP specification RFC 3621, a SIP INVITE message is used for initiating a session among communicating endpoints. Often the body of the SIP INVITE message is used as a mechanism for endpoints to negotiate and mutually agreed upon parameters of a media stream that the SIP invitation is trying to establish. The message body often contains a description of parameters of the media streams that will be used in the communication session, such as the bit rate, codec scheme, etc. This description, in an exemplary embodiment, can utilize the Session Description Protocol (SDP). It is noted that, whenever a SIP endpoint receives an INVITE message without an SDP message body, the endpoint evokes a “200 OK” response that contains an SDP message representing media stream parameters that are preferred by, or acceptable to, the SIP endpoint. This SDP information may be proxied to another endpoint to achieve agreement in media stream parameters even before the two endpoints have been placed in direct communication with one another.

The media server 305, as in step 433, transmits a “200 OK” message (with SDP) to the CMS 309b. Per step 435, the CMS 309b generates an INVITE (with SDP) message to the SC 303. Upon receiving the INVITE message, the SC 303 sends an INVITE message to a first TUA (TUA-1), per step 437. TUA-1 then responds, as in step 439, to the INVITE with a “183 Session Progress” message, which contains the SDP; this “183” message is conveyed to the CMS 309b by the SC 303 (per step 441). The CMS 309b, in step 443, sends a Call Progress message to the AS 309a. Next, the OUA and the TUA-1 communicate via the media server 305, which provides an RTP—Ringing to the TUA-1, as in step 445. The exchange of SDP permits an RTP path so that ring tones can be transmitted. At this point, the originating user agent can hear ring tones generated at the TUA-1.

Upon operator answer, the TUA-1, per step 447, transmits a “200 OK” message to the SC 303. The SC 303 communicates the “200 OK” message to the CMS 309b (step 449), which responds with an ACK message, as in step 450. The SC 303 then sends the ACK message to the TUA-1 (step 451). In addition, the CMS 309b sends, as in step 453, an Answer message to the AS 390a. In step 455, both call legs RTP paths are setup to the media server 305.

Subsequently, the media server 305 can bridge the two call legs, as next explained.

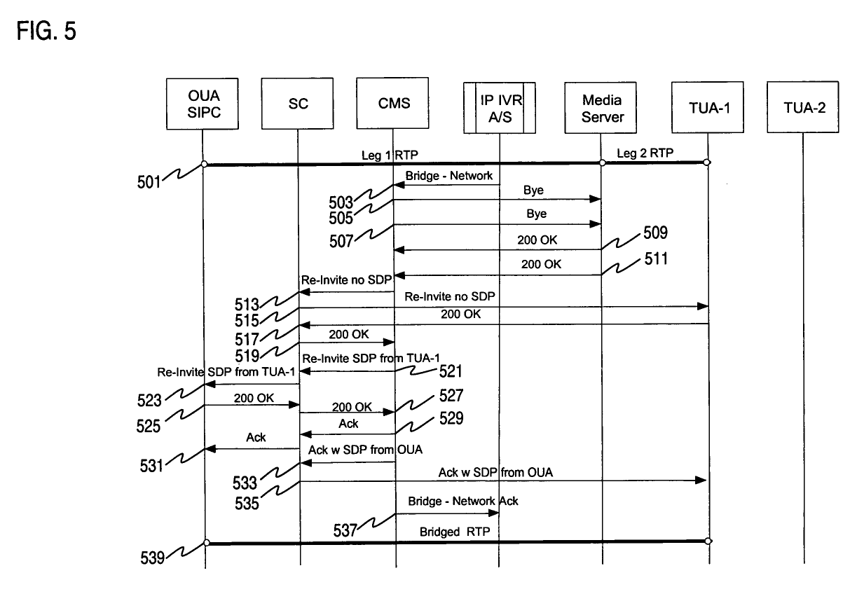

FIG. 5 is a diagram showing network bridging of call legs, according to an embodiment of the present invention. Continuing with the call flow example of FIG. 5, step 501 involves the media server 305 controlling the call legs, Leg 1 RTP and Leg 2 RTP. In step 503, the AS 309a sends a Bridge-Network message to the CMS 309b. The CMS 309b responds, per steps 505 and 507, with two BYE messages to the media server 305 corresponding to the call legs. The BYE message (or request) indicates to the server 305 that the call should be released. In steps 509 and 511, the media server 305 answers the CMS 309b with “200 OK” messages. Next, the CMS 309b issues a Re-INVITE (with no SDP) message to the SC 303, per step 513. Consequently, the CMS 309b relays, as in step 515, this message to the TUA-1. The TUA-1 then sends a “200 OK” message to the SC 303, and the SC 303 forwards the “200 OK” message to the CMS 309b (steps 517 and 519).

In step 521, the CMS submits a Re-INVITE (with SDP) message from TUA-1 to the SC 303; the SC 303 then forwards this message to the OUA (step 523). The OUA responds, as in step 525, with a “200 OK” to the SC 303, which transmits such response to the CMS 309b (step 527). In steps 529 and 531, ACK messages are sent from the CMS 309b to the SC 303 and then from the SC 303 to the OUA. The CMS 309b, per step 533, sends an ACK with SDP from the OUA to the SC 303. In step 535, the SC 303 forwards the ACK with the SDP from the OUA to the TUA-1. The CMS 309b, as in step 537, sends a Bridge—Network ACK message to the AS 309a. Accordingly, the OUA and the TUA-1 are bridged (step 539).

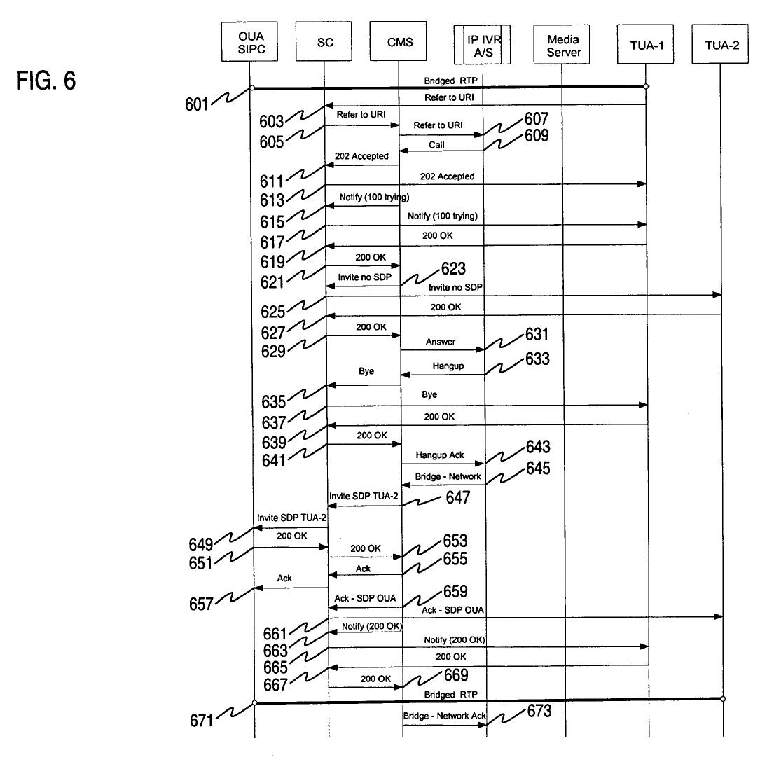

FIG. 6 is a call flow of a Session Initiation Protocol (SIP) Refer method without media, according to an embodiment of the present invention. From step 601, in which the OUA and the TUA-1 are bridged, then the TUA-1 sends a REFER to URI message to the SC 303, which responds by relaying the REFER message to the CMS 309b (steps 603 and 605). In step 607, the CMS 309b sends the REFER to URI message to the AS 309a. The AS 309a then sends a Call message to the CMS 309b, as in step 609. A “202 Accepted” message is sent by the CMS 309b to the SC 303 (step 611). The SC 303, per step 613, transmits the “202 Accepted” message to the TUA-1. In step 615, the CMS 309b sends a Notify (100 trying) message to the SC 303; this message is then conveyed to the TUA-1 (step 617). The TUA-1 responds to the SC 303 with a “200 OK” message (step 619); the SC 303 sends the “200 OK” message to the CMS 309b, per step 621. In step 623, the CMS 309b transmits an INVITE (with no SDP) to the SC 303. Next, the SC 303 sends an INVITE (with no SDP) to the TUA-2 (step 625). The TUA-2 in turn sends a “200 OK” message in response to the INVITE, per step 627. In step 629, the SC 303 transmits the “200 OK” message to the CMS 309b; the CMS 309b then sends an Answer message to the AS 309a, per step 631. The AS 309a, as in step 633, transmits a Hangup message to the CMS 309b.

Subsequently, the CMS 309b issues a Bye message to the SC 303, per step 635. Next, the SC 303 sends a Bye message, as in step 637, to the TUA-1, which responds with a “200 OK” message (step 639). The SC 303 then sends the “200 OK” message to the CMS 309b, which submits a Hangug Ack message to the AS 309a (steps 641 and 643). In step 645, the AS 303 sends a Bridge—Network message to the CMS 309b. Per step 647, the CMS sends an INVITE (with SDP) corresponding to the TUA-2 to the SC 303, which forwards the message to the OUA (step 649).

The OUA then sends a “200 OK” message to the SC 303, per step 651; the SC 303 forwards the “200 OK” message to the CMS 309b, which acknowledges with an ACK message (steps 653 and 655). The SC 303 also forwards the ACK message to the OUA, as in step 657. Further, the CMS 309b transmits, as in step 659, an ACK message (with SDP OUA) to the SC 303. The SC 303, per step 661, submits the ACK message (with SDP OUA) to TUA-2.

In step 663, the CMS 309b sends a Notify (200 OK) to the SC 303, which relays this message to the TUA-1 (step 665). The TUA-1, in turn, sends a “200 OK” message to the SC 303 (step 667). In step 669, the SC 303 transmits the “200 OK” message to the CMS 309b. At this point, the OUA and the TUA-2 are bridged, per step 671. In step 673, the CMS 309b acknowledges with a Bridge-Network Ack message to the AS 309a.

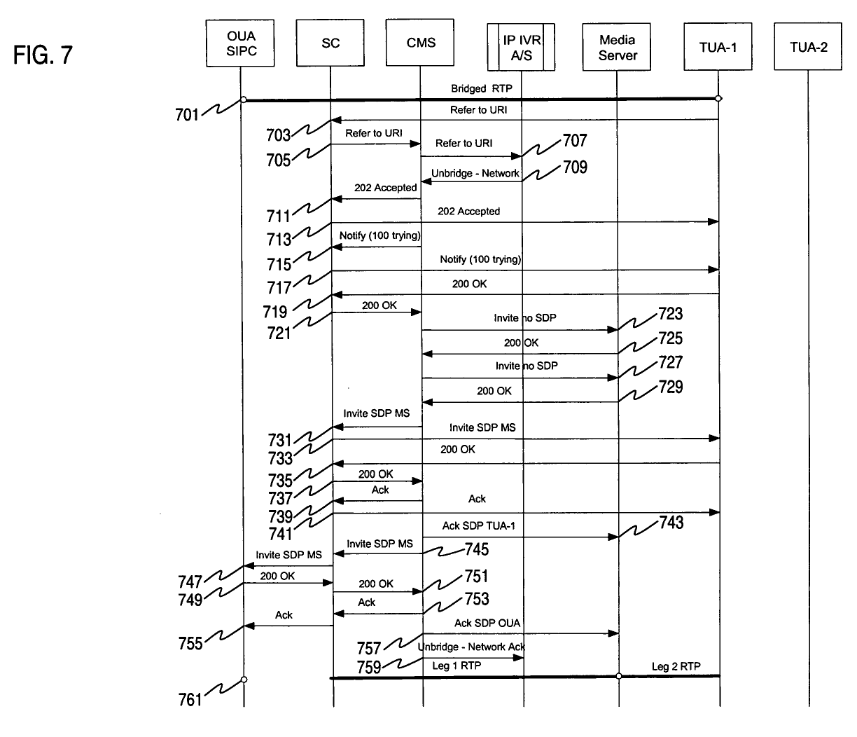

FIG. 7 is a call flow of a SIP Refer method with media (retrieve from the network), according to an embodiment of the present invention. Under this scenario, the OUA and the TUA-1 are bridged (step 701). In step 703, the TUA-1 sends a REFER to URI message to the SC 303. The SC 303 responds, as in step 705, by relaying the REFER message to the CMS 309b. The CMS 309b sends the REFER to URI message to the AS 309a, per step 707.

In step 709, the AS 309a sends an Unbridge—Network message to the CMS 309b. The CMS 309b responds, as in step 711, by sending a “202 Accepted” message to the SC 303, which forwards the message to the TUA-1. The CMS 309b, as in step 715, sends a Notify (100 Trying) message to the SC 303; the SC 303 sends this message to the TUA-1, per step 717. The TUA-1 then sends a “200 OK” message to the SC 303 (step 719). The “200 OK” message forwarded by the SC 303, as in step 721, to the CMS 309b.

The CMS 309b now sends an INVITE (no SDP) to the media server 305, per step 723. The media server 305 responds with a “200 OK” message to the CMS 309b. Again, the CMS 309b sends, as in step 727, an INVITE (no SDP) to the media server 305, which responds with a “200 OK” message (step 729). Next, the CMS 309b transmits an INVITE (with SDP from media server), per step 731, to the SC 303, which forwards the INVITE to the TUA-1. In step 735, the TUA-1 sends a “200 OK” message to the SC 303. The SC 303 subsequently sends a “200 OK” message to the CMS 309b, as in step 737. The CMS 309b acknowledges with an ACK message, which is forwarded by the SC 303 to the TUA-1 (steps 739 and 741). The CMS 309b also sends an ACK (with SDP associated with the TUA-1) to the media server 305, as in step 743.

In step 745, the CMS 309b transmits an INVITE (with SDP associated with the media server 305) to the SC 303, which sends the message to the OUA (step 747). The OUA responds with a “200 OK” message, which the SC 303 sends to the CMS 309b (steps 749 and 751). The CMS 309b acknowledges with an ACK message, which also further sent to the OUA via the SC 303, per steps 753 and 755. The CMS 309b sends an ACK (with SDP associated with the OUA), as in step 757, to the media server 305. Additionally, the CMS 309b sends an Unbridge-Network Ack message to the AS 309a, per step 759. At this point, the media server 305 controls both call legs (step 761).

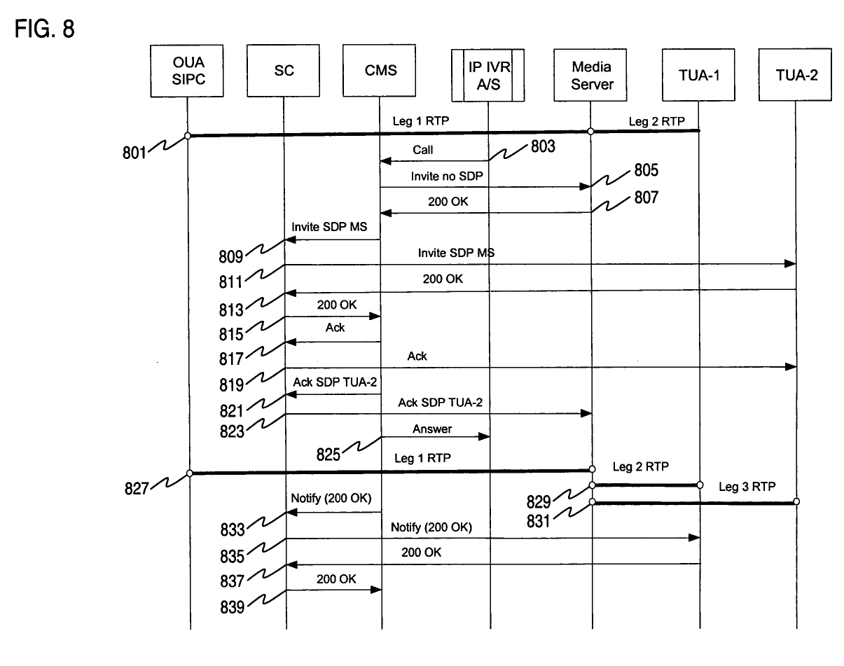

FIG. 8 is a call flow of a SIP Refer method with media (outdial), according to an embodiment of the present invention. Consistent with the example of FIG. 7, the media server 305 controls both call legs (step 801). In steps 803 and 805, the AS 309a sends a Call message to the CMS 309b, which responds with an INVITE (with no SDP) to the media server 305. The media server 305 then forwards a “200 OK” message back to the CMS 309b, as in step 807. The CMS 309b then sends an INVITE (with SDP associated with the media server 305) to the SC 303 (step 809). Per step 811, the SC 303 transmits the INVITE (with SDP associated with the media server 305) to the TUA-2. The TUA-2 responds to the received INVITE message with a “200 OK” message, as in step 813. The SC 303 relays the “200 OK” message to the CMS 309b, which acknowledges with an ACK to the SC 303 (step 817). The SC 303 in turn, per step 819, sends the ACK to the TUA-2.

In step 821, the CMS 309b provides an ACK (with SDP associated with TUA-2) to the SC 303, which conveys this message to the media server 305 (step 823). The CMS 309b then sends, as in step 825, an Answer message to the AS 309a. Per steps 827, 829 and 831, the first call leg is parked at the media server 305, as well as the second and third call legs. Call treatment of the call legs can be performed, according to one embodiment of the present invention. In step 833, the CMS 309b sends a Notify (200 OK) message to the SC 303; this message is forwarded, per step 835, to the TUA-1. The TUA-1, as in step 837, transmits a “200 OK” message back to the SC 303; this message is then provided to the CMS 309b, per step 839.

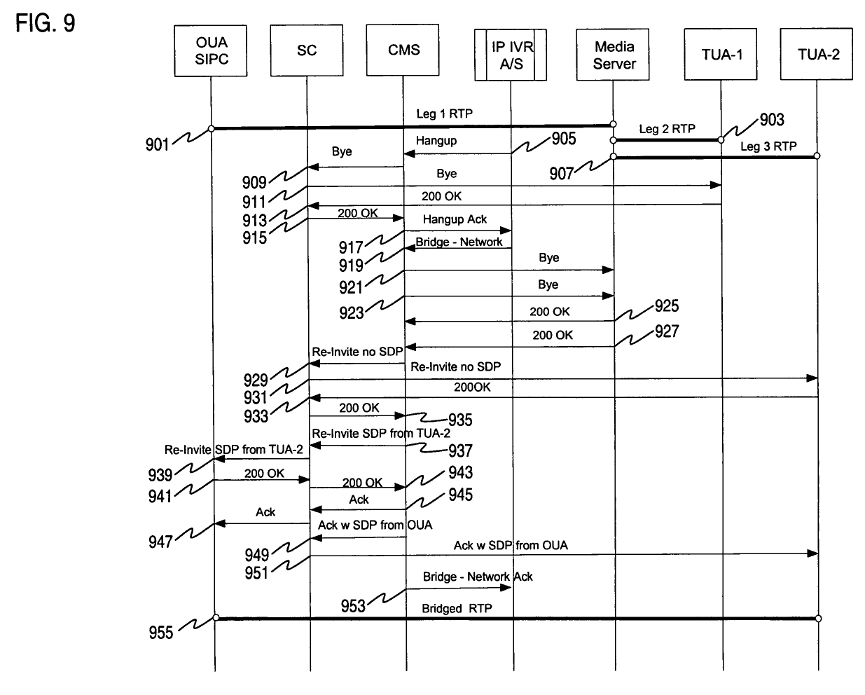

FIG. 9 is a call flow of a SIP Refer method with media (network bridge), according to an embodiment of the present invention. Continuing with the call flow example of FIG. 8, the call legs, leg 1 RTP, leg 2 RTP, and leg 3 RTP (steps 901, 903, and 905), are handled by the media server 305. To bridge the call between the OUA and the TUA-2, the AS 309a begins the process by sending a Hangup message to the CMS 309b (step 907). The CMS 309b accordingly sends, per step 909, a BYE message to the SC 303. The SC 303 forwards the BYE message to the TUA-1 (step 911), which responds with a “200 OK” message, per step 913.

In step 915, the SC 303 sends a “200 OK” message to the CMS 309b; the CMS 309b transmits a Hangup ACK message to the AS 309a (step 917). In step 919, the AS 309a sends a Bridge—Network message to the CMS 309b, which transmits two BYE messages to the media server 305, per steps 921 and 923. The media server 305, as in steps 925 and 927, correspondingly sends two “200 OK” messages back to the CMS 309b. In step 929, the CMS 309b sends a Re-INVITE (no SDP) message to the SC 303, which relays, as in step 931, the Re-INVITE to the TUA-2. The TUA-2 replies with a “200 OK” message to the SC 303, per step 933. In step 935, the “200 OK” message is sent to the CMS 309b by the SC 303. The CMS 309b now transmits a Re-INVITE (with SDP from the TUA-2) to the SC 303, per step 937. In step 939, the SC 303 forwards the Re-INVITE (with SDP from the TUA-2) to the OUA. The OUA provides, as in step 941, a “200 OK” message to the SC 303. The SC 303 sends the “200 OK” message the CMS 309b, which responds with an ACK message (steps 943 and 945). The SC 303 then transmits the ACK message to the OUA, as in step 947.

In step 949, the CMS 309b also sends an ACK (with SDP from OUA) to the SC 303, which provides the SDP from the OUA to the TUA-2 via an ACK message (step 951). In step 953, the CMS 309b sends a Bridge—Network ACK message to the AS 309a. Consequently, the OUA and the TUA-2 are bridged, per step 955.

As described above, hybrid transfers, which are transfers between different types of endpoints (IP to TDM or vice versa), are particularly useful to customers with multiple TDM call centers, whereby such customers seek to add IP call centers. That is, this capability can facilitate a gradual transition from a circuit switched telephony system to a packet-switched telephony system. In part, this type of transfer advantageously provides a mechanism to retain TnT revenue in an IP telephony environment, while enabling a service that is cost-effective to the customers. The hybrid transfer mechanism, according to one embodiment of the present invention, can support a variety of telephony features: 8xx outdials, EVS Route plan outdials Busy Ring no Answer, Network Call Redirect, ICR for in network queueing, and Local and Network Databases to allow abbreviated specification of transfer target. Another advantage is the visibility of the transfer, with respect to Enhanced Call Routing and Traffic View Reporting. The hybrid transfer mechanism is also consistent with existing Blind/Attended/Conference transfers. According to one embodiment of the present invention, the audible DTMF tones can be eliminated on the IP initiated transfers.

One of ordinary skill in the art would recognize that the processes for providing network-based call processing of packetized voice calls may be implemented via software, hardware (e.g., general processor, Digital Signal Processing (DSP) chip, an Application Specific Integrated Circuit (ASIC), Field Programmable Gate Arrays (FPGAs), etc.), firmware, or a combination thereof. Such exemplary hardware for performing the described functions is detailed below.

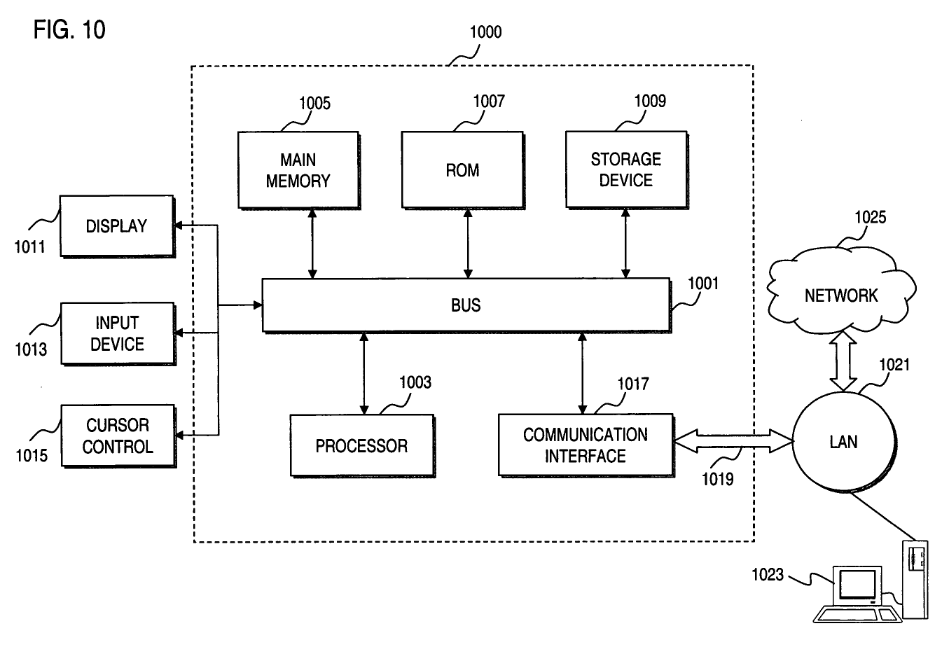

FIG. 10 illustrates a computer system 1000 upon which an embodiment according to the present invention can be implemented. For example, the processes of FIGS. 2A-2C and 4-9 can be implemented using the computer system 1000. The computer system 1000 includes a bus 1001 or other communication mechanism for communicating information and a processor 1003 coupled to the bus 1001 for processing information. The computer system 1000 also includes main memory 1005, such as a random access memory (RAM) or other dynamic storage device, coupled to the bus 1001 for storing information and instructions to be executed by the processor 1003. Main memory 1005 can also be used for storing temporary variables or other intermediate information during execution of instructions by the processor 1003. The computer system 1000 may further include a read only memory (ROM) 1007 or other static storage device coupled to the bus 1001 for storing static information and instructions for the processor 1003. A storage device 1009, such as a magnetic disk or optical disk, is coupled to the bus 1001 for persistently storing information and instructions.

The computer system 1000 may be coupled via the bus 1001 to a display 1011, such as a cathode ray tube (CRT), liquid crystal display, active matrix display, or plasma display, for displaying information to a computer user. An input device 1013, such as a keyboard including alphanumeric and other keys, is coupled to the bus 1001 for communicating information and command selections to the processor 1003. Another type of user input device is a cursor control 1015, such as a mouse, a trackball, or cursor direction keys, for communicating direction information and command selections to the processor 1003 and for controlling cursor movement on the display 1011.

According to one embodiment of the invention, the processes described herein are performed by the computer system 1000, in response to the processor 1003 executing an arrangement of instructions contained in main memory 1005. Such instructions can be read into main memory 1005 from another computer-readable medium, such as the storage device 1009. Execution of the arrangement of instructions contained in main memory 1005 causes the processor 1003 to perform the process steps described herein. One or more processors in a multi-processing arrangement may also be employed to execute the instructions contained in main memory 1005. In alternative embodiments, hard-wired circuitry may be used in place of or in combination with software instructions to implement the embodiment of the present invention. Thus, embodiments of the present invention are not limited to any specific combination of hardware circuitry and software.

The computer system 1000 also includes a communication interface 1017 coupled to bus 1001. The communication interface 1017 provides a two-way data communication coupling to a network link 1019 connected to a local network 1021. For example, the communication interface 1017 may be a digital subscriber line (DSL) card or modem, an integrated services digital network (ISDN) card, a cable modem, a telephone modem, or any other communication interface to provide a data communication connection to a corresponding type of communication line. As another example, communication interface 1017 may be a local area network (LAN) card (e.g. for Ethernet™ or an Asynchronous Transfer Model (ATM) network) to provide a data communication connection to a compatible LAN. Wireless links can also be implemented. In any such implementation, communication interface 1017 sends and receives electrical, electromagnetic, or optical signals that carry digital data streams representing various types of information. Further, the communication interface 1017 can include peripheral interface devices, such as a Universal Serial Bus (USB) interface, a PCMCIA (Personal Computer Memory Card International Association) interface, etc. Although a single communication interface 1017 is depicted in FIG. 10, multiple communication interfaces can also be employed.

The network link 1019 typically provides data communication through one or more networks to other data devices. For example, the network link 1019 may provide a connection through local network 1021 to a host computer 1023, which has connectivity to a network 1025 (e.g. a wide area network (WAN) or the global packet data communication network now commonly referred to as the “Internet”) or to data equipment operated by a service provider. The local network 1021 and the network 1025 both use electrical, electromagnetic, or optical signals to convey information and instructions. The signals through the various networks and the signals on the network link 1019 and through the communication interface 1017, which communicate digital data with the computer system 1000, are exemplary forms of carrier waves bearing the information and instructions.

The computer system 1000 can send messages and receive data, including program code, through the network(s), the network link 1019, and the communication interface 1017. In the Internet example, a server (not shown) might transmit requested code belonging to an application program for implementing an embodiment of the present invention through the network 1025, the local network 1021 and the communication interface 1017. The processor 1003 may execute the transmitted code while being received and/or store the code in the storage device 1009, or other non-volatile storage for later execution. In this manner, the computer system 1000 may obtain application code in the form of a carrier wave.

The term “computer-readable medium” as used herein refers to any medium that participates in providing instructions to the processor 1003 for execution. Such a medium may take many forms, including but not limited to non-volatile media, volatile media, and transmission media. Non-volatile media include, for example, optical or magnetic disks, such as the storage device 1009. Volatile media include dynamic memory, such as main memory 1005. Transmission media include coaxial cables, copper wire and fiber optics, including the wires that comprise the bus 1001. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the present invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

While the present invention has been described in connection with a number of embodiments and implementations, the present invention is not so limited but covers various obvious modifications and equivalent arrangements, which fall within the purview of the appended claims.

### APPENDIX

Acronyms:

AAL ATM Adaptation Layer

ACD Automatic Call Distribution

AS Application Server

ATM Asynchronous Transfer Mode

B2BUA Back to Back User Agent

CD-ROM Compact Disc—Read Only Memory

CDRW Compact Disc Read-Writable

CMS Common Media Services

CPE Customer Premises Equipment

DSP Digital Signaling Processing

DTMF Dual Tone Multi-Frequency

DVD Digital Versatile Disc (formerly Digital Video Disc)

ECR Enhanced Call Routing

EPROM Electrically Programmable Read-Only Memory

EVS Enhanced Voice Services

ICR Intelligent Call Routing

IETF Internet Engineering Task Force

IN Intelligent Network

IP Internet Protocol

IPMS IP Media Server

IR Infrared

ISP Internet Service Provider

ITU International Telecommunication Union

IVR Interactive Voice Response

IP Internet Protocol

LAN Local Area Network

OUA Originating User Agent

PBX Private Branch Exchange

PCMCIA Personal Computer Memory Card International Association

PDA Personal Digital Assistant

PROM Programmable Read-Only Memory

PSTN Public Switched Telephone Network

RAM Random Access Memory

RF Radio Frequency

RFC Request for Comment

RLT Release Line Trunk

RTP Real-time Transport Protocol

SC Service Controller

SCP Service Control Point

SCTP Stream Control Transmission Protocol

SDP Session Description Protocol

SIBB Service Independent Building Block

SIP Session Initiation Protocol

SIPC SIP Client

SS7 Signaling System 7

TDM Time Division Multiplexing

TUA Terminating User Agent

TnT Takeback and Transfer

UAC User Agent Client

UAS User Agent Server

UDP User Datagram Protocol

USB Universal Serial Bus

VOIP Voice-over-IP

VRU Voice Response Unit

WAN Wide Area Network

What is claimed is:

1. A method for providing network-based call processing, the method comprising:
receiving a packetized voice call from a first station;
queueing the packetized voice call at a pre-designated queue maintained within a network of a service provider; and
selectively forwarding the packetized voice call to a second station.

2. A method according to claim 1, wherein the packetized voice call is parked at a first call center associated with the first station, the method further comprising:
transferring the packetized voice call to the second station within a second call center.

3. A method according to claim 2, further comprising:
establishing a conferencing session, associated with the packetized voice call, between an agent of the first call center and an agent of the second call center.

4. A method according to claim 3, further comprising:
placing the packetized voice call on hold during the conferencing session between the agents.

5. A method according to claim 2, wherein the transfer of the packetized voice call is based on one or more criteria including traffic loading of a destination call center.

6. A method according to claim 2, wherein the packetized voice call is routed through the network to the second call center.

7. A method according to claim 2, further comprising:
directing the call to a third call center as part of a Take-Back-and-Transfer (TnT) operation.

8. A method according to claim 2, wherein the call is transferred without use of a dedicated trunk between the first call center and the second call center.

9. A method according to claim 2, wherein the second station is a Time Division Multiplexing (TDM) phone.

10. A method according to claim 1, wherein the packetized voice call is established with the second station via Session Initiation Protocol (SIP) signaling.

11. A method according to claim 1, further comprising:
queueing another packetized voice call at the first station; and
routing the other packetized voice call via the network to the second station.

12. A method according to claim 1, further comprising:
releasing media resources associated with call treatment for the packetized voice call; and
initiating transfer of the packetized voice call to the second station.

13. A system for providing call processing within a network of a service provider, the system comprising:
a queue configured to receive a packetized voice call from a first station; and
a call processor configured to select the queue, wherein the packetized voice call is selectively forwarded to a second station.

14. A system according to claim 13, wherein the packetized voice call is parked at a first call center associated with the first station, and the call processor transfers the packetized voice call to the second station within a second call center.

15. A system according to claim 14, further comprising:
a conferencing module configured to establish a conferencing session, associated with the packetized voice call, between an agent of the first call center and an agent of the second call center.

16. A system according to claim 15, wherein the call parking platform places the packetized voice call on hold during the conferencing session between the agents.

17. A system according to claim 14, wherein the transfer of the packetized voice call is based on one or more criteria including traffic loading of a destination call center.

18. A system according to claim 14, wherein the packetized voice call is routed through the network to the second call center.

19. A system according to claim 14, wherein the conferencing module is configured to direct the call to a third call center as part of a Take-Back-and-Transfer (TnT) operation.

20. A system according to claim 14, wherein the call is transferred without use of a dedicated trunk between the first call center and the second call center.

21. A system according to claim 14, wherein the second station is a Time Division Multiplexing (TDM) phone.

22. A system according to claim 13, wherein the packetized voice call is established with the second station via Session Initiation Protocol (SIP) signaling.

23. A system according to claim 13, wherein another packetized voice call is queued at the first station, and the call processor routes the other packetized voice call via the network to the second station.

24. A system according to claim 13, further comprising:
a media server configured to perform call treatment, wherein resources of the media server is released, and transfer of the packetized call is initiated.

25. A communication system for supporting network-based call processing of packetized voice calls, the system comprising:
a gateway configured to receive a first leg of a packetized voice call from a first endpoint;
a service controller configured to establish a second leg of the call with a second endpoint;
an application server configured to receive signaling for parking the first call leg; and
a media server configured to park the first call leg, and to bridge the first call leg and the second call leg.

26. A system according to claim 25, wherein the packetized voice call is parked at a first call center associated with the first station, and the call is transferred to a second call center associated with the second station.

27. A system according to claim 26, wherein the second station is a phone configured to operate with a circuit switched telephone network.

28. A system according to claim 25, wherein the service controller provides Session Initiation Protocol (SIP) proxy functions for handling the call.
